(19) United States
(12) Patent Application Publication
(10) Pub. No.: US 2023/0180805 A1
(43) Pub. Date: Jun. 15, 2023

(54) Opacifying Agents

(71) Applicant: EFCO Products Inc., Poughkeepsie, NY (US)

(72) Inventors: Vijayabhaskar Poreddy, Poughkeepsie, NY (US); Pratistha Banerjee, Poughkeepsie, NY (US); Brianna Benson, Poughkeepsie, NY (US); David Cullinan, Montvale, NJ (US)

(73) Assignee: EFCO Products Inc., Poughkeepsie, NY (US)

(21) Appl. No.: 17/552,045

(22) Filed: Dec. 15, 2021

(51) Int. Cl. A23L 29/212; A23L 29/294; A23L 29/10; A23L 29/231; A23L 29/262

(52) U.S. Cl. CPC A23L 29/212; A23L 29/294; A23L 29/10; A23L 29/231; A23L 29/262

(57) ABSTRACT

A powder composition for use as an opacifying agent and processes for preparing the same. The powder composition comprises calcium sulfate and a stabilizer. At least a portion of the calcium sulfate has a particle size equal to or less than 50 microns. The powder composition can be prepared by combining the calcium sulfate with the stabilizer to form a uniform dry blend, followed by micronizing the uniform dry blend to form a powder. The powder composition can be used as an opacifying agent in foods and beverages, as well as in various non-food formulations.

### FIELD OF THE INVENTION

The present disclosure relates generally to calcium sulfate-based opacifying agents, to formulations comprising such opacifying agents, and to methods of preparing such opacifying agents.

### BACKGROUND OF THE INVENTION

Titanium dioxide (TiO₂) is commonly used as an opacifying agent in the production of various industrial and consumer goods, including foods and beverages. However, it may pose health risks to those who are exposed to its particulates during the manufacture of such goods, as well as to the end consumers of foods, beverages, and cosmetics that contain it. For example, titanium dioxide is categorized by the International Agency for Research on Cancer (IARC) as a Group 2B carcinogen (meaning “possibly carcinogenic to humans”). Furthermore, the National Institute for Occupational Safety and Health (NIOSH) recommends airborne exposure limits of 2.4 mg/m³ for fine titanium dioxide and 0.3 mg/m³ for ultrafine (including engineered nanoscale) titanium dioxide, as time-weighted average (TWA) concentrations for up to 10 hours per day during a 40-hour work week. And while titanium dioxide has been approved by the FDA for use as a color additive for coloring food, it cannot be used in quantities that exceed 1% by weight of the food. Moreover, the European Food Safety Authority (EFSA) has recently concluded that titanium dioxide can no longer be considered safe as a food additive and, starting in 2022, will ban its use in this capacity.

Given the recognition of these potential health risks, efforts have been made in industry to find alternatives to titanium dioxide. Such alternatives include starch-based opacifying agents, pectin and gum-based opacifying agents, fats, oils, and liquid emulsions, dairy-based ingredients, powdered emulsions, and calcium carbonate. However, none of these alternatives are comparable to titanium dioxide in its versatility and functionality as an opacifying agent, particularly with regard to the diverse formulation and processing requirements of food and beverage applications. For example, starch-based opacifying agents lose opacifying functionality in applications requiring heat processing and/or low pH. Pectin and gum-based opacifying agents tend to change product viscosity and their opacifying functionality is dependent on pH and/or the presence of a calcium source. Fats, oils, and liquid emulsions are not stable in water-based applications. They may also require homogenization, require a higher level of usage in various application, and change the texture/mouthfeel of the final product. Dairy-based ingredients contain potential allergens. Powdered emulsions, besides being relatively costly, have limited solubility in certain applications and reduced heat stability during manufacturing drying processes. Calcium carbonate buffers acidic ingredients, limiting its use in low pH applications. Moreover, it is currently only FDA approved for use as a color additive in hard and soft candy, mints, and chewing gum.

Accordingly, there remains a continuing need for an opacifying agent that is a versatile replacement for titanium dioxide, on that can be used in the production of a wide range of both industrial and consumer goods, including foods and beverages, but does not pose both the same potential risks to health.

### EMBODIMENTS OF THE INVENTION

In addition to other advantages, this versatile replacement is found in the compositions according to the present invention, which can be used as an opacifying agent in a wide range of both industrial and consumer goods, including foods and beverages, but obviates the potential health risks posed by the use of titanium dioxide in the same capacity. The calcium sulfate, stabilizers, and additional optional components, such as anticaking agents and powdered emulsifiers, of the compositions according to the present invention are substances that can be added directly to human food, as determined by the FDA, are generally recognized as safe (“GRAS”), and are approved to be used in accordance with good manufacturing practices. Compared to commercially available titanium dioxide, the compositions according to the present invention provide opacifying functionality with a concomitant reduction in nanoparticles. Compared to other existing opacifying agents, the compositions according to the present invention provide superior opacifying functionality with exceptional processing tolerance in a greater number of applications, as well as superior opacifying functionality across a broader spectrum of physical and chemical properties. Moreover, since the compositions according to the present invention are not subject to lipid oxidation, they exhibit a superior shelf-life compared to fat-based opacifying agents. Furthermore, the superior opacification functionality of the compositions according to the present invention can withstand a broad range of processing parameters, examples of which include, but are not limited to, heat treatment (examples of which include, but are not limited to, cooking, canning, and pasteurization), freezing, fermenting, pickling, smoking, drying, curing, high pressure processing, modified atmosphere packaging, or any combination thereof. Additionally, the compositions according to the present invention maintain their superior opacification functionality across a broad spectrum of physical and chemical product parameters, examples of which include, but are not limited to, high and low levels of macronutrients (e.g., fat, protein, and carbohydrates), micronutrients, and water content.

An embodiment of the present invention is a powder composition comprising calcium sulfate and a stabilizer, wherein at least a portion of the calcium sulfate has a particle size equal to or less than 50 microns. In certain embodiments, the stabilizer is selected from the group consisting of gum arabic, modified food starch, carrageenan, gellan gum, xanthan gum, methylcellulose, sodium carboxymethylcellulose, agar-agar, guar gum, locust (i.e., carob) bean gum, gum karaya (i.e., sterculia), pectins, and any combination thereof.

In certain embodiments, the powder composition of the present invention further comprises an anticaking agent. In certain embodiments, the anticaking agent is selected from the group consisting of calcium phosphate, silicon dioxide, sodium aluminosilicate, magnesium stearate, and any combination thereof. In certain embodiments of the powder composition of the present invention, the stabilizer is gum arabic and the anticaking agent is calcium phosphate.

In certain embodiments, the powder composition of the present invention further comprises a powdered emulsifier. In certain embodiments, the powdered emulsifier is selected from the group consisting of sucrose fatty acid esters, sucrose oligoesters, polysorbate 60, polysorbate 65, polysorbate 80, sorbitan monostearate, sodium stearoyl lactylate, lecithin, monoglycerides, diglycerides, propylene glycol monoesters of fats, propylene glycol monoesters of fatty acids, propylene glycol diesters of fats, propylene glycol diesters of fatty acids, and any combination thereof.

Another embodiment of the present invention is a formulation comprising the powder composition of the present invention. In certain embodiments, the formulation is selected from the group consisting of water-based formulations, fat-based formulations, powder-based formulations, and any combination thereof.

In certain embodiments, the formulation is a food or beverage. In certain embodiments, the food or beverage is full-fat, low-fat, or fat-free. In certain embodiments, the formulation is a food product selected from the group consisting of gelatins, puddings, fillings, icings, glazes, coatings, confections, frostings, sugar blends, sweet sauces, toppings, syrups, jams, jellies, soft candies, baked goods, and baking mixes. In certain embodiments, the formulation is a beverage product selected from the group consisting of alcoholic beverages, nonalcoholic beverages, non-alcoholic beverage bases, coffee products, tea products, processed fruits, fruit juices, processed vegetables, and vegetable juices. In certain embodiments, the formulation is a dairy product or dairy product analog selected from the group consisting of cheese, milk products, coffee creamers, yogurts, frozen dairy desserts, and frozen dairy mixes. In certain embodiments, the formulation is a food product selected from the group consisting of condiments, mayonnaise products, relishes, gravies, sauces, fats, oils, dressings, soups, and soup mixes.

In certain embodiments, the formulation is a non-food formulation. In certain embodiments, the non-food formulation is selected from the group consisting of paints, plastics, paper, ceramics, fabrics, printing ink, and cosmetics.

Another embodiment of the present invention is a process for preparing the powder composition of the present invention, comprising the steps of (1) combining the calcium sulfate with the stabilizer to form a uniform dry blend and (2) micronizing the uniform dry blend to form a powder.

In certain embodiments, the uniform dry blend formed in the process of the present invention is micronized using a jet mill. In certain embodiments, the uniform dry blend formed in the process of the present invention is micronized to form a powder having a D99-value of 22 microns and a D100-value of 32 microns.

In certain embodiments, the process of the present invention further comprises combining the calcium sulfate with an anticaking agent, in addition to the stabilizer, to form the dry blend. In certain embodiments, the stabilizer and the anticaking agent used in the process of the present invention is, respectively, gum arabic and calcium phosphate. In certain embodiments, the process of the present invention further comprises combining the calcium sulfate with a powdered emulsifier, in addition to the stabilizer and the anticaking agent, to form the dry blend.

In certain embodiments, the calcium sulfate used in the process of the present invention has a brightness greater than or equal to 96. In certain embodiments, the calcium sulfate used in the process of the present invention has a pH lower than or equal to 7.2. In certain embodiments, the calcium sulfate used in the process of the present invention has a compacted bulk density greater than or equal to 70%.

### DETAILED DESCRIPTION OF THE INVENTION

One aspect of the present invention is directed to compositions for use as opacifying agents in food, beverage, and non-food applications. The powder compositions according to the present invention comprise at least two components: calcium sulfate and a stabilizer. The compositions according to the present invention may be in the form of a powder, in the form of a paste, or in the form of a dispersion. The paste and dispersion forms of the compositions according to the present invention can be formed by mixing powder form(s) thereof invention with a liquid, such as water, or with a gel.

The calcium sulfate in the compositions according to the present invention can be present therein in any hydration state, including partial hydration states and/or mixtures of hydration states. In certain embodiments, the hydration state of the calcium sulfate present in the compositions according to the present invention is anhydrous calcium sulfate (i.e., CaSO₄), calcium sulfate dihydrate (i.e., CaSO₄·2H₂O), or any combination thereof.

At least a portion of the calcium sulfate in the compositions according to the present invention is present therein as particles having a particle size equal to or less than 50 μm (microns). In certain embodiments, all or at least a portion of the calcium sulfate is present in the compositions according to the present invention as particles having a D99-value and/or a D100-value of 50 μm, of 49 μm, of 48 μm, of 47 μm, of 46 μm, of 45 μm of 44 μm, of 43 μm, of 42 μm, of 41 μm, of 40 μm, of 39 μm, of 38 μm, of 37 μm, of 36 μm, of 35 μm, of 34 μm, of 33 μm, of 32 μm, of 31 μm, of 30 μm, of 29 μm, of 28 μm, of 27 μm, of 26 μm, of 25 μm, of 24 μm, of 23 μm, of 22 μm, of 21 μm, of 20 μm, of 19 μm, of 18 μm, of 17 μm, of 16 μm, of 15 μm, of 14 μm, of 13 μm, of 12 μm, of 11 μm, of 10 μm, of 9 μm, of 8 μm, of 7 μm, of 6 μm, of 5 μm, of 4 μm, of 3 μm, of 2 μm, or of 1 μm. In certain other embodiments, all or at least a portion of the calcium sulfate is present in the compositions according to the present invention as particles having a D99-value and/or a D100-value of 950 nm (nanometers), of 900 nm, of 850 nm, of 800 nm, of 750 nm, of 700 nm, of 650 nm, of 600 nm, of 550 nm, of 500 nm, of 450 nm, of 400 nm, of 350 nm, of 300 nm, of 250 nm, of 200 nm, of 150 nm, or of 101 nm. These foregoing values are to be construed for the purposes of the present invention as also encompassing and explicitly disclosing values of less than those amounts (e.g., less than 40 μm, 30 μm or less, etc.). These foregoing values are also to be construed for the purposes of the present invention as also encompassing and explicitly disclosing values that represent endpoints of a range (e.g., from 1 μm to 50 μm), as well as every possible value that exists within such ranges (e.g., 48.2 μm, 26.6 μm, 12.3 μm, 1.5 μm, etc.).

In certain embodiments, the composition according to the present invention comprises particles having a D99-value of 22 microns and a D100-value of 32 microns. In certain other embodiments, the composition according to the present invention comprises particles having a D100-value less than or equal to 32 μm.

Any known stabilizer can be used in the compositions according to the present invention. Examples of such stabilizers can include, but are not limited to, gum arabic, collagens, egg whites, gelatins, whey, food starches, modified food starches, carrageenan, gellan gum, xanthan gum, guar gum, locust (carob) bean gum, karaya gum (sterculia gum), tragacanth gum, alginates, methylcellulose, sodium carboxymethylcellulose, agar-agar, pectins, sodium pyrophosphate, lecithins, hydrolyzed lecithins, monoglycerides, diglycerides, arabinogalactan, chewing gum base, carrageenan with polysorbate 80, salts of carrageenan, furcelleran, salts of furcelleran, glycine, sodium stearyl fumarate, sucrose acetate isobutyrate (SAIB), propylene glycol alginate, bakers yeast glycan, chondrus extract, alginic acid, enzyme-modified lecithin, ammonium alginate, calcium acetate, calcium alginate, calcium gluconate, calcium lactate, calcium stearate, dextrin, corn gluten, wheat gluten, microparticulated protein product, potassium alginate, potassium chloride, potassium hydroxide, sodium alginate, aluminum monostearate, aluminum distearate, aluminum tristearate, ammonium citrate, ammonium potassium hydrogen phosphate, calcium glycerophosphate, calcium phosphate, calcium hydrogen phosphate, calcium oleate, calcium acetate, calcium carbonate, calcium ricinoleate, calcium stearate, disodium hydrogen phosphate, magnesium glycerophosphate, magnesium stearate, magnesium phosphate, magnesium hydrogen phosphate, monosodium citrate, disodium citrate, trisodium citrate, monopotassium citrate, dipotassium citrate, tripotassium citrate, potassium oleate, potassium stearate, sodium pyrophosphate, sodium stearate, sodium tetrapyrophosphate, stannous stearate, zinc orthophosphate, zinc resinate, and any combination thereof. In certain embodiments, the compositions according to the present invention can comprise two or more stabilizers.

The compositions according to the present invention may optionally further comprise one or more anticaking agents to impart enhanced flowability and minimize caking. Alternatively, the one or more anticaking agents can be separately employed in powder applications in conjunction with the compositions according to the present invention. Examples of such anticaking agents can include, but are not limited to, calcium phosphate, tricalcium phosphate, silicon dioxide, sodium aluminosilicate, magnesium stearate, powdered cellulose, sodium bicarbonate, sodium ferrocyanide, potassium ferrocyanide, calcium ferrocyanide, bone phosphate, sodium silicate, calcium silicate, magnesium silicate, magnesium trisilicate, sodium carbonate, potassium carbonate, ammonium carbonate, magnesium carbonate, potassium chloride, calcium chloride, ammonium chloride, magnesium chloride, stannous chloride, sodium sulfates, potassium sulfates, ammonium sulfate, magnesium sulfate, copper sulfate, aluminum sulfate, aluminum sodium sulfate, aluminum potassium sulfate, aluminum ammonium sulfate, sodium hydroxide, potassium hydroxide, calcium hydroxide, ammonium hydroxide, magnesium hydroxide, calcium oxide, magnesium oxide, dicalcium diphosphate, sodium aluminum phosphate, kaolin, gluconic acid, glucono-delta-lactone, sodium gluconate, potassium gluconate, calcium gluconate, ferrous gluconate, ferrous lactate, talc, potassium aluminum silicate, calcium aluminosilicate, bentonite, aluminum silicate, stearic acid, iron ammonium citrate, yellow prussiate of soda, sodium monomethyl naphthalene sulfonates, sodium dimethyl naphthalene sulfonates, hydrated sodium calcium aluminosilicate, tricalcium silicate, potassium acid tartrate, sorbitol, carnauba wax, and any combination thereof. In certain embodiments, the compositions according to the present invention can comprise two or more anticaking agents. In certain other embodiments, the anticaking agent is tricalcium phosphate.

The compositions according to the present invention may optionally further comprise one or more powdered emulsifiers to reduce usage levels (i.e., the amount of the compositions according to the present invention needed to impart the requisite and/or desired opacity when used). Alternatively, the one or more powdered emulsifiers can be separately employed in various applications in conjunction with the compositions according to the present invention. Examples of such powdered emulsifiers can include, but are not limited to, sucrose fatty acid esters, sucrose oligoesters, polysorbate 60, polysorbate 65, polysorbate 80, sorbitan monostearate, sorbitan tristearate, sorbitan monolaurate, sodium stearoyl-2-lactylate, lecithins, monoglycerides, diglycerides, propylene glycol monoesters of fats, propylene glycol monoesters of fatty acids, propylene glycol diesters of fats, propylene glycol diesters of fatty acids, glycerol monolaurate, ethoxylated monoglycerides, diacetyl tartaric acid esters of monoglycerides, succinylated monoglycerides, calcium stearoyl-2-lactylate, polyglycerol polyricinoleate, ammonium phosphatide, stearyl monoglyceridyl citrate, succistearin (stearoyl propylene glycol hydrogen succinate), dioctyl sodium sulfosuccinate, hydroxylated lecithin, sodium lauryl sulfate, acetylated monoglycerides, lactylic esters of fatty acids, lactylated fatty acid esters of glycerol and propylene glycol, glyceryl-lacto esters of fatty acids, polyglycerol esters of fatty acids, fatty acids, salts of fatty acids, hydroxypropyl cellulose, methyl ethyl cellulose, hydroxypropyl methylcellulose, gum ghatti, monosodium phosphate derivatives of monodiglycerides, monosodium phosphate derivatives of diglycerides, sodium hypophosphate, sodium lactate, sodium tartrate, sodium potassium tartrate, whey protein concentrate, and any combination thereof. In certain embodiments, the compositions according to the present invention can comprise two or more powdered emulsifiers. In certain embodiments, the powdered emulsifier is sucrose esters.

The calcium sulfate, stabilizer(s), and any other optional components, such as anticaking agent(s) and/or powdered emulsifier(s), can be present in the compositions according to the present invention in any weight, volume, or molar percent or ratio relative to each other necessary to achieve a required and/or desired level of opacity when used. In certain embodiments, the calcium sulfate can be present in a composition according to the present invention in an amount of 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% by weight, volume, or moles, relative to the total weight, volume, or moles, respectively, of a composition according to the present invention, with the balance being the weight/volume/moles percent of the stabilizer or a combination of the stabilizer with other components, such as one or more anticaking agents and/or powdered emulsifiers, also present in the composition. These foregoing values are to be construed for the purposes of the present invention as also encompassing and explicitly disclosing values of at least those amounts or less than those amounts (e.g., at least 75%, less than 95%, etc.). These foregoing values are also to be construed for the purposes of the present invention as also encompassing and explicitly disclosing values that represent endpoints of a range (e.g., from 50% to 99%, from 75% to 95%), as well as every possible value that exists within such ranges (e.g., 75.3%, 84.6%, 94.4%, etc.). In certain embodiments, the calcium sulfate is present in a composition according to the present invention in an amount in the range of from 75% to 95% by weight, based on the total weight of the composition according to the present invention.

Conversely, in certain embodiments, the stabilizer(s) and optional anticaking agent(s) and powdered emulsifier(s) can be present in a composition according to the present invention in an amount of 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50%, by weight, volume, or moles, relative to the total weight, volume, or moles, respectively, of a composition according to the present invention, with the balance being the weight/volume/moles percent of the calcium sulfate or a combination of the calcium sulfate with other components, such as stabilizer(s), and optional anticaking agent(s) and/or powdered emulsifier(s), also present in the composition. These foregoing values are to be construed for the purposes of the present invention as also encompassing and explicitly disclosing values of at least those amounts or less than those amounts (e.g., at least 2%, less than 10%, etc.). These foregoing values are also to be construed for the purposes of the present invention as also encompassing and explicitly disclosing values that represent endpoints of a range (e.g., from 1% to 50%, from 2% to 10%), as well as every possible value that exists within such ranges (e.g., 2.6%, 5.4%, 9.6%, etc.). In certain embodiments, the stabilizer(s) and optional anticaking agent(s) and powdered emulsifier(s) are each present in a composition according to the present invention in an amount in the range of from 2% to 10% by weight, respectively, based on the total weight of the composition according to the present invention.

The stabilizer(s), optional anticaking agent(s) and powdered emulsifier(s), and any other components present in the compositions according to the present invention can be of any particle size conducive to the opacification properties of these compositions. These components can have a particle size (maximum, average, or otherwise) identical to or different from that of the calcium sulfate present in the compositions according to the present invention, as disclosed herein. In certain embodiments, at least a portion of the stabilizer(s), optional anticaking agent(s) and powdered emulsifier(s), and any other components are present in the compositions according to the present invention as particles having a particle size equal to or less than 50 μm. In certain embodiments, all or at least a portion of the stabilizer(s), optional anticaking agent(s) and powdered emulsifier(s), and any other components are present in the compositions according to the present invention as particles having a D99-value and/or a D100-value of 50 μm, of 49 μm, of 48 μm, of 47 μm, of 46 μm, of 45 μm, of 44 μm, of 43 μm, of 42 μm, of 41 μm, of 40 μm, of 39 μm, of 38 μm, of 37 μm, of 36 μm, of 35 μm, of 34 μm, of 33 μm, of 32 μm, of 31 μm, of 30 μm, of 29 μm, of 28 μm, of 27 μm, of 26 μm, of 25 μm, of 24 μm, of 23 μm, of 22 μm, of 21 μm, of 20 μm, of 19 μm, of μm, of 17 μm, of 16 μm, of 15 μm, of 14 μm, of 13 μm, of 12 μm, of 11 μm, of 10 μm, of 9 μm, of 8 μm, of 7 μm, of 6 μm, of 5 μm, of 4 μm, of 3 μm, of 2 μm, or of 1 μm. In certain other embodiments, all or at least a portion of the stabilizer(s), optional anticaking agent(s) and powdered emulsifier(s), and any other components are present in the compositions according to the present invention as particles having a a D99-value and/or D100-value of 950 nm (nanometers), of 900 nm, of 850 nm, of 800 nm, of 750 nm, of 700 nm, of 650 nm, of 600 nm, of 550 nm, of 500 nm, of nm, of 400 nm, of 350 nm, of 300 nm, of 250 nm, of 200 nm, of 150 nm, or of 101 nm. These foregoing values are to be construed for the purposes of the present invention as also encompassing and explicitly disclosing values of less than those amounts (e.g., less than 40 μm, 30 μm or less, etc.). These foregoing values are also to be construed for the purposes of the present invention as also encompassing and explicitly disclosing values that represent endpoints of a range (e.g., from 1 μm to less than 50 μm), as well as every possible value that exists within such ranges (e.g., 48.2 μml, 26.6 μm, 12.3 μm, 1.5 μml, etc.). In certain embodiments, the stabilizer(s), optional anticaking agent(s) and powdered emulsifier(s), and any other components are present in the compositions according to the present invention as particles having a D100-value of 32 μm and a D-99-value of 22 μm. In certain other embodiments, the stabilizer(s), optional anticaking agent(s) and powdered emulsifier(s), and any other components are present in the compositions according to the present invention as particles having a D100-value less than or equal to 32 μm. In yet certain other embodiments, one, more than one, or all of the stabilizer(s), optional anticaking agent(s) and powdered emulsifier(s), and any other components present in the compositions according to the present invention each have a particle size of greater than 50 μm.

Another aspect of the present invention is directed to processes for preparing the compositions according to the present invention. The compositions according to the present invention can be prepared by any suitable method known in the art.

In certain embodiments, the processes for preparing the compositions according to the present invention comprise a first step of dry-blending calcium sulfate with one or more stabilizers, and one or more optional adjuncts, such as the anticaking agents and emulsifiers described above, to form a uniform dry blend. This uniform dry blend is then subsequently micronized to form a powder composition wherein at least a portion of the particles of calcium sulfate, one or more stabilizers, and optional adjuncts have a particle size equal to or less than 50 μm, as described above. Superior ingredient functionality in application can be observed when the one or more stabilizer, and optional adjuncts are dry-blended with the calcium sulfate prior to micronization. In certain other embodiments, the processes for preparing the compositions according to the present invention comprise a first step of micronizing calcium sulfate to form a powder composition wherein the particles of calcium sulfate have a maximum particle size of 50 μm, as described above. This micronized calcium sulfate is then subsequently uniformly dry-blended with one or more stabilizers, and one or more optional adjuncts, such as the anticaking agents and emulsifiers described above. Aspects of these two embodiments of the processes for preparing the compositions according to the present invention can be combined. For example, the calcium sulfate and the one or more stabilizers are first uniformly dry-blended and subsequently micronized to form a powder composition wherein at least a portion of the particles of calcium sulfate and the one or more stabilizers have a particle size equal to or less than 50 μm. This micronized uniform dry-blend according to the present invention can then subsequently be further dry-blended with one or more optional adjuncts, such as anticaking agents and emulsifiers, which independently have or does not have a particle size equal to or less than 50 μm.

The uniform dry-blending can be performed in any manner known in the art, whether manually or mechanically. The micronization likewise can be performed in any manner known in the art, such as via micronizing the calcium sulfate alone or as part of a uniform dry blend using a jet mill. Superior flowability (i.e., minimized caking) of the compositions according to the present invention can observed when micronization is performed using a jet mill, since it avoids the production of excess heat during micronization. Examples of such jet mills include, but are not limited to, spiral jet mills, loop jet mills, and fluidized bed jet mills.

Any source of calcium sulfate can be used to prepare the compositions according to the present invention. The calcium sulfate used to prepare the compositions according to the present invention can have any hydration state, including partial hydration states and/or mixtures of hydration states, as described above. In certain embodiments, the hydration state of the calcium sulfate used to prepare the compositions according to the present invention is anhydrous calcium sulfate, calcium sulfate dihydrate, or any combination thereof. The calcium sulfate used to prepare the compositions according to the present invention can have a brightness in the range of from 84 to 99. In certain embodiments, the calcium sulfate used to prepare the compositions according to the present invention has a brightness of 84 or greater, 85 or greater, 86 or greater, 87 or greater, 88 or greater, 89 or greater, 90 or greater, 91 or greater, 92 or greater, 93 or greater, 94 or greater, 95 or greater, 96 or greater, 97 or greater, or 98 or greater. In certain embodiments, superior opacifying functionality is observed when the calcium sulfate used to prepare the compositions according to the present invention has a brightness equal to or greater than 96. The calcium sulfate used to prepare the compositions according to the present invention can have a pH in the range of from 6.8 to 10.8. Superior functionality in low pH applications is observed when the calcium sulfate used to prepare the compositions according to the present invention has a pH less than or equal to 7.2. Therefore, in certain embodiments, the calcium sulfate used to prepare the compositions according to the present invention can have a pH of 7.2 or lower, 7.1 or lower, 7.0 or lower, or 6.9 or lower. Superior manufacturing efficiency in the production of the invention is observed when the calcium sulfate used to prepare the compositions according to the present invention has a compacted bulk density equal to or greater than 70%. Therefore, in certain embodiments, the calcium sulfate used to prepare the compositions according to the present invention can have a compacted bulk density of 70% or greater, 75% or greater, 80% or greater, 85% or greater, 90% or greater, or 95% or greater.

Another aspect of the present invention is directed to formulations comprising the compositions according to the present invention, where the composition(s) according to the present invention are dispersed therein for the purpose of imparting opacity to the formulation to any desired degree. The formulations according to the present invention can be water-based formulations, fat-based formulations, powder-based formulations, or any combination thereof. In certain embodiments, one or more water-based formulations according to the present invention and one or more fat-based formulations according to the present invention can be combined to form a formulation according to the present invention that is an emulsion. In certain embodiments, one or more powder-based formulations can be combined with one or more water-based formulations according to the present invention and/or one or more fat-based formulations according to the present invention to form a formulation according to the present invention that is a dispersion. Such combined formulations can include products that may separate during extended or prolonged shelf storage, such as, for example, salad dressings and paints, but which can subsequently be re-emulsified and/or re-dispersed.

In certain embodiments, the formulations according to the present invention can be a food or beverage product, particularly those that might have otherwise contained titanium dioxide as an opacifier. Examples of food products according to the present invention can include, but are not limited to, gelatins, puddings, fillings (bakery or otherwise), icings, glazes, coatings, confections, frostings, sugar blends, sweet sauces, toppings (including dry blends/topical coatings, such as donut sugar), syrups, jams, jellies, soft candies, baked goods, baking mixes, condiments, mayonnaise products, relishes, gravies, sauces, fats, oils, dressings (salad or otherwise), soups, and soup mixes. Examples of beverage products according to the present invention can include, but are not limited to, alcoholic beverages, non-alcoholic beverages, non-alcoholic beverage bases, coffee products, tea products, processed fruits, fruit juices, processed vegetables, and vegetable juices. In certain embodiments, the food or beverage product according to the present invention is a dairy product or dairy product analog selected from the group consisting of cheese, milk products, coffee creamers, yogurts, yogurt drinks, frozen dairy desserts, and frozen dairy mixes. Any of these food or beverage products according to the present invention can be full-fat, low-fat, or fat-free.

In certain embodiments, the formulations according to the present invention can be a non-food formulation, particularly those that might have otherwise contained titanium dioxide as an opacifier. Examples of such non-food formulations include, but are not limited to, paints, pigments, plastics, paper, ceramics, catalysts, fabrics, printing ink, roofing granules, glass, welding fluxes, and cosmetics.

The composition(s) according to the present invention can be present in a formulation in any amount necessary to impart a desired degree of opacity to the formulation. Such amounts of the composition(s) according to the present invention can be present in the formulation in any ratio relative to the other component(s) of the formulation or as a percentage by weight based on the total weight of the formulation, as a percentage by weight based on the total volume of the formulation, or as a percentage by volume based on the total volume of the formulation. In certain embodiments, the composition(s) according to the present invention can be present in a formulation in an amount of 0.01%, 0.02%, 0.03%, 0.04%, 0.05%, 0.06%, 0.07%, 0.08%, 0.09%, 0.10%, 0.15%, 0.20%, 0.25%, 0.30%, 0.35%, 0.40%, 0.45%, 0.50%, 0.55%, 0.60%, 0.70%, 0.75%, 0.80%, 0.85%, 0.90%, 0.95%, 1.0%, 1.1%, 1.2%, 1.3%, 1.4%, 1.5%, 1.6%, 1.7%, 1.8%, 1.9%, 2.0%, 2.5%, 3.0%, 3.5%, 4.0%, 4.5%, 5.0%, 6.0%, 6.5%, 7.0%, 7.5%, 8.0%, 8.5%, 9.0%, 9.5%, or 10% by weight based on the total weight of the formulation, by weight based on the total volume of the formulation, or by volume based on the total volume of the formulation. These foregoing values are to be construed for the purposes of the present invention as also encompassing and explicitly disclosing values of at least those amounts and/or of less than those amounts (e.g., at least 1.0%, less than 2.0%, etc.). These foregoing values are also to be construed for the purposes of the present invention as also encompassing and explicitly disclosing values that represent endpoints of a range (e.g., from 0.01% to 10%), as well as every possible value that exists within such ranges (e.g., 0.043%, 0.62%, 1.17%, 8.31%, etc.).

The composition(s) according to the present invention can be incorporated into a formulation by any method(s)/process(es) that ultimately imparts the necessary and/or desired level of opacity to the formulation. Examples of such method(s)/process(es) can include, but are not limited, those method(s)/process(es) or equivalents thereof by which titanium dioxide or other opacifying agents might be incorporated into a formulation, whether the formulation is a food, beverage, non-food formulation, or otherwise. In certain embodiments, the composition(s) according to the present invention can be incorporated into a formulation via manual and/or mechanical mixing with one or more of the other components of the formulation to form a uniform/homogenous mixture, after which the uniform/homogenous mixture is further processed as necessary.

The foregoing description and the claims will be more readily understood by referring to the following non-limiting examples of the present invention, which are given to illustrate certain specific embodiments thereof rather than limit its scope. While the following non-limiting examples illustrate certain specific embodiments of the present invention, it will be apparent and manifest to, and envisioned by, persons of ordinary skill in the art reading this description that various modifications, rearrangements, changes, and variations may be made thereto without departing from the spirit and scope of the underlying present invention and that the same is not limited to the particular embodiments shown and described herein. In other words, the following examples are not intended to be exhaustive in scope, but rather are encompassed within the spirit and scope of the present invention and, thus, the present invention should not be construed as limited to the following embodiments.

### EXAMPLES

### Example 1—Inventive Powder Composition

All materials are Food Chemicals Codex (FCC) and/or approved food-grade materials. Anhydrous calcium sulfate (i.e., CaSO₄) or calcium sulfate dihydrate (i.e., CaSO₄2H₂O) (94.654 grams), gum arabic (3.205 grams), and tricalcium phosphate (2.141 grams) are mechanically dry blended until uniform. The resulting uniform dry blend of calcium sulfate, gum arabic, and tricalcium phosphate are then charged into a jet mill. The uniform dry blend is then micronized in the jet mill until it has a D99-value of 22 microns and a D100-value of 32 microns as measured by a particle size analyzer.

### Example 2—Inventive Bavarian Creme Filling

The inventive powder composition of Example 1 (0.5 to 1 grams) is combined with following components:

| | Weight |
|---|---|
| Component | (grams) |
| Water | 50 to 70 |
| Sugar | 15 to 30 |
| Corn Syrup | 5 to 10 |
| Modified Food Starch | 5 to 10 |
| Palm Oil | 2 to 5 |
| Emulsifier | 0.5 to 2 |
| Natural & Artificial Flavors | 0.1 to 1 |
| Glucono Delta Lactone | 0.1 to 1 |
| Salt | 0.1 to 1 |
| Potassium Sorbate | <0.1 |
| Sodium Benzoate | <0.1 |
| Hydrocolloid | <0.1 |
| Yellow Color | <0.1 |

and mixed. The mixture is then thermally processed to achieve commercial sterility at a temperature greater than or equal to 190 Fahrenheit in a steam jacketed kettle and/or via direct steam injection to form the inventive Bavarian Creme Filling.

1. A powder composition comprising calcium sulfate and a stabilizer, wherein at least a portion of the calcium sulfate has a particle size equal to or less than 50 microns, wherein the stabilizer is selected from the group consisting of gum arabic, collagens, egg whites, gelatins, whey, carrageenan, gellan gum, xanthan gum, methylcellulose, sodium carboxymethylcellulose, agar-agar, guar gum, locust bean gum, gum karaya, pectins, tragacanth gum, alginates, sodium pyrophosphate, lecithins, hydrolyzed lecithins, monoglycerides, diglycerides, arabinogalactan, chewing gum base, carrageenan with polysorbate 80, salts of carrageenan, furcelleran, salts of furcelleran, glycine, sodium stearyl fumarate, sucrose acetate isobutyrate, propylene glycol alginate, baker's yeast glycan, chondrus extract, alginic acid, enzyme-modified lecithin, ammonium alginate, calcium acetate, calcium alginate, calcium gluconate, calcium lactate, calcium stearate, dextrin, corn gluten, wheat gluten, microparticulated protein product, potassium alginate, potassium chloride, potassium hydroxide, sodium alginate, aluminum monostearate, aluminum di stearate, aluminum tristearate, ammonium citrate, ammonium potassium hydrogen phosphate, calcium glycerophosphate, calcium phosphate, calcium hydrogen phosphate, calcium oleate, calcium acetate, calcium carbonate, calcium ricinoleate, calcium stearate, disodium hydrogen phosphate, magnesium glycerophosphate, magnesium stearate, magnesium phosphate, magnesium hydrogen phosphate, monosodium citrate, disodium citrate, trisodium citrate, monopotassium citrate, dipotassium citrate, tripotassium citrate, potassium oleate, potassium stearate, sodium pyrophosphate, sodium stearate, sodium tetrapyrophosphate, stannous stearate, zinc orthophosphate, zinc resinate, and any combination thereof, and wherein the powder composition does not comprise titanium dioxide.

2. The powder composition of claim 1, wherein the stabilizer is selected from the group consisting of gum arabic, carrageenan, gellan gum, xanthan gum, methylcellulose, sodium carboxymethylcellulose, agar-agar, guar gum, locust bean gum, gum karaya, pectins, and any combination thereof.

3. The powder composition of claim 1, wherein the powder composition further comprises an anticaking agent.

4. The powder composition of claim 3, wherein the anticaking agent is selected from the group consisting of calcium phosphate, silicon dioxide, sodium aluminosilicate, magnesium stearate, and any combination thereof.

5. The powder composition of claim 3, wherein the stabilizer is gum arabic and the anticaking agent is calcium phosphate.

6. The powder composition of claim 1, wherein the powder composition further comprises a powdered emulsifier.

7. The powder composition of claim 6, wherein the powdered emulsifier is selected from the group consisting of sucrose fatty acid esters, sucrose oligoesters, polysorbate 60, polysorbate 65, polysorbate 80, sorbitan monostearate, sodium stearoyl lactylate, lecithin, monoglycerides, diglycerides, propylene glycol monoesters of fats, propylene glycol monoesters of fatty acids, propylene glycol diesters of fats, propylene glycol diesters of fatty acids, and any combination thereof.

8. A formulation comprising a powder composition wherein the powder composition comprises calcium sulfate and a stabilizer, wherein at least a portion of the calcium sulfate has a particle size equal to or less than 50 microns, wherein the powder composition does not comprise titanium dioxide, and wherein the formulation is a food product selected from the group consisting of gelatins, puddings, fillings, icings, glazes, confections, frostings, sugar blends, sweet sauces, toppings, syrups, jams, jellies, soft candies, baked goods, baking mixes.

9. The formulation of claim 8, wherein the formulation is a water-based formulations formulation, a fat-based formulation, a powder-based formulation, or any combination thereof.

10. (canceled)

11. The formulation of claim 8, wherein the food product is full-fat, low-fat, or fat-free.

12. (canceled)

13. A formulation comprising the powder composition of claim 1, wherein the formulation is a beverage product selected from the group consisting of alcoholic beverages, nonalcoholic beverages, non-alcoholic beverage bases, coffee products, tea products, processed fruits, fruit juices, processed vegetables, and vegetable juices.

14. A formulation comprising a powder composition, wherein the powder composition comprises calcium sulfate and a stabilizer, wherein at least a portion of the calcium sulfate has a particle size equal to or less than 50 microns, wherein the powder composition does not comprise titanium dioxide, and wherein the formulation is a dairy product or dairy product analog selected from the group consisting of milk products, coffee creamers, yogurts, frozen dairy desserts, and frozen dairy mixes.

15. A formulation comprising a powder composition, wherein the powder composition comprises calcium sulfate and a stabilizer, wherein at least a portion of the calcium sulfate has a particle size equal to or less than 50 microns, wherein the powder composition does not comprise titanium dioxide, and wherein the formulation is a food product selected from the group consisting of condiments, mayonnaise products, relishes, gravies, sauces, fats, oils, dressings, soups, and soup mixes.

16. A formulation comprising the powder composition of claim 1, wherein the formulation is a non-food formulation.

17. The formulation of claim 16, wherein the non-food formulation is selected from the group consisting of paints, plastics, paper, ceramics, fabrics, printing ink, and cosmetics.

18. A process for preparing the powder composition of claim 1, comprising:
(1) combining the calcium sulfate with the stabilizer to form a uniform dry blend; and
(2) micronizing the uniform dry blend to form a powder.

19. The process of claim 18, wherein the uniform dry blend is micronized using a jet mill.

20. The process of claim 18, wherein the uniform dry blend is micronized to form a powder having a D99-value of 22 microns and a D100-value of 32 microns.

21. The process of claim 18, further comprising combining the calcium sulfate with an anticaking agent, in addition to the stabilizer, to form the dry blend.

22. The process of claim 21, wherein the stabilizer is gum arabic and the anticaking agent is calcium phosphate.

23. The process of claim 22, further comprising combining the calcium sulfate with a powdered emulsifier, in addition to the stabilizer and the anticaking agent, to form the dry blend.

24. The powder composition of claim 1, wherein the calcium sulfate has a brightness greater than or equal to 96.

25. The powder composition of claim 1, wherein the calcium sulfate has a pH lower than or equal to 7.2.

26. The process of claim 18, wherein the calcium sulfate has a compacted bulk density greater than or equal to 70%.

27. The formulation of claim 14, wherein the formulation is a water-based formulation, a fat-based formulation, a powder-based-formulation, or any combination thereof.

28. The formulation of claim 14, wherein the dairy product or dairy product analog is full-fat, low-fat, or fat-free.

29. The formulation of claim 15, wherein the formulation is a water-based formulation, a fat-based formulation, a powder-based-formulation, or any combination thereof.

30. The formulation of claim 15, wherein the food product or food product analog is full-fat, low-fat, or fat-free.
